(19) United States
(12) Patent Application Publication
(10) Pub. No.: US 2014/0259425 A1
(43) Pub. Date: Sep. 18, 2014

(54) Pillow for Support of The Lower Leg

(71) Applicant: Lynn A. Lovechio, Wakefield, RI (US)

(72) Inventor: Lynn A. Lovechio, Wakefield, RI (US)

(21) Appl. No.: 14/208,967

(22) Filed: Mar. 13, 2014

Related U.S. Application Data
(60) Provisional application No. 61/785,416, filed on Mar. 14, 2013.

(51) Int. Cl. A61G 7/075; A61G 7/057

(52) U.S. Cl. CPC A61G 7/0755; A61G 7/057
USPC 5/648

(57) ABSTRACT

The invention relates to a pillow for supporting the lower leg of a used and methods of use.

### RELATED APPLICATIONS

The present application claims priority to U.S. Application Ser. No. 61/785,416, filed Mar. 14, 2013, hereby incorporated by reference in its entirety.

### TECHNICAL FIELD

The present invention relates to a pillow to support the lower leg.

### BACKGROUND OF THE INVENTION

There is a large population of individuals at risk of developing decubitus ulcers or other bed sores, including in the heel region of the foot where it is very common for the tissue to break down. This population includes elderly persons, hospital patients who are bedridden or spend a substantial period of their time in bed and individuals that are in some way debilitated. This type of sore can become very painful, as well as dangerous.

To prevent or treat decubitus ulcer formation at the heel, the subject's foot must be maintained in a position that prevents pressure on the heel, which normally results from the heel resting against the bed surface for extended periods of time, for example, when the subject is bedridden.

There is a long felt need in the art for a method of preventing the occurrence of decubitus ulcers of the heel, by preventing the heel(s) of the subject from contacting a surface.

There is also a long felt need in the art for a method of treating a decubitus ulcer of the heel in a subject in need, by preventing the heel(s) of the subject from contacting a surface.

### BRIEF SUMMARY OF THE INVENTION

The invention provides for a pillow for preventing the heels of a user from contacting a surface, the pillow having a proximal end and a distal end, the pillow having a length extending between the proximal end and the distal end; and the length of the pillow being about equal to or less than the length from the user's knees to the user's ankles.

A pillow of the invention has one or more of the following properties: prevents the user's heels from contacting a surface to treat or prevent skin ulcers of the heels; is of a shape that keeps the user's heel elevated even if the user shifts position; prevents the user's heels from contacting a surface when the user is positioned either horizontally on their back or laterally on their side; prevents the user's heels from contacting a surface should the user change position; prevents hyperextension of the knees and/or hips; minimizes or prevents hip or knee contracture; prevents hyperextension of the knees of a user; and offers sufficient support to maintain the legs in a flat position.

The pillow of the invention can have at least any of the shapes presented in FIG. 10. The pillow of the invention can have, at the distal end any of one of:
two opposing protruding portions substantially forming a T-shape (a T-pillow).
two opposing protruding portions that are substantially rectangular.
two opposing protruding portions that are substantially square.
two opposing protruding portions that are not perpendicular to the left and right side of the pillow.
two protruding portions substantially comprising a Y-shape; and
one or more protruding portions that are neither substantially rectangular or square and wherein the edges or the protruding portions are rounded.

The pillow of the invention can also have a shape wherein the distal end has an opposing, protruding end that is rounded; or wherein the distal end has an opposing protruding end that is semi-circular.

In one embodiment, the distal end has two opposing protruding portions substantially forming a T-shape.

In another embodiment, the pillow comprises a top surface and a bottom surface, the top and bottom surface being substantially flat.

In another embodiment, the pillow comprises a left side surface and a right side surface.

In another embodiment, the pillow comprises a front surface and a rear surface.

In another embodiment, the edge of the pillow comprising the distal end and the front surface is beveled.

In another embodiment, the edge of the pillow comprising the proximal surface and the back surface is beveled.

In another embodiment, the interior of the pillow comprises a dense material.

In another embodiment, the dense material is selected from the group consisting of: foam, memory foam and gel, or a combination thereof.

In another embodiment, the pillow further comprises a cover.

In another embodiment, the cover of the pillow is waterproof.

In another embodiment, the cover of the pillow can be cleaned and sanitized and the pillow can be used.

In another embodiment, the pillow further comprises a material to provide for wicking moisture away from the user.

In another embodiment, the protruding portions of the pillow are substantially rectangular.

In another embodiment, the protruding portions of the pillow are substantially square.

In another embodiment, the protruding portions are not perpendicular to the left and right side of the pillow.

In another embodiment, the distal end has two protruding portions substantially comprising a Y-shape.

In another embodiment, the protruding portions are neither substantially rectangular or square and the edges or the protruding portions are rounded.

In another embodiment, the distal end has an opposing, protruding end that is rounded.

In another embodiment, the distal end has an opposing protruding end that is semi-circular.

The invention also provides for a method of preventing formation of pressure sores on the heels of a subject comprising: providing a pillow having a proximal end and a distal end, the pillow having a length extending between the proximal end and the distal end; and positioning the subject's legs over the pillow, the subject's feet extending past the distal end, the subject's ankles being about aligned with the distal end, the length being about equal to or less than the length from the subject's knee to the subject's ankles.

In one embodiment, the subject is positioned horizontally on their back.

In another embodiment, the subject is positioned on their side.

In another embodiment, the subject's feet extend beyond the distal end of the pillow.

In another embodiment, the portion of the user's legs that contact the pillow are substantially flat.

In another embodiment, the portion of the user's legs that contact the pillow are substantially straight.

In another embodiment, with reference to FIG. 1, the pillow of the invention has dimensions wherein:
distance “A” is from about 4 inches to about 20 inches;
distance “B” is from about 1 inch to about 8 inches;
distance “C” is from about 5 inches to about 28 inches;
distance “D” is from about 18 inches to about 32 inches;
distance “E” is from about 10 inches to about 24 inches;
distance “F” is from about 0.5 inches to about 8 inches; and
distance “G” is from about 2 inches to about 8 inches.

In another embodiment, with reference to FIG. 1, the pillow of the invention has dimensions wherein: distance “A” is from about 10 inches to about 12 inches, and distance “F” is from about 3 inches to about 4 inches.

In another embodiment, with reference to FIG. 1, the pillow of the invention has dimensions wherein: distance “A” is from about 12 inches to about 14 inches, and distance “F” is from about 3 inches to about 4 inches.

In another embodiment, with reference to FIG. 1, the pillow of the invention has dimensions wherein: distance “A” is from about 14 inches to about 18 inches, and distance “F” is from about 3 inches to about 4 inches.

In another embodiment, with reference to FIG. 1, the pillow of the invention has dimensions wherein: distance “A” is from about 6 inches to about 8 inches, and distance “F” is from about 1.5 inches to about 2 inches.

In another embodiment, with reference to FIG. 1, the pillow of the invention has dimensions wherein: distance “A” is from about 8 inches to about 10 inches, and distance “F” is from about 1.5 inches to about 2 inches.

In another embodiment, with reference to FIG. 1, the pillow of the invention has dimensions wherein: distance “A” is from about 10 inches to about 12 inches, and distance “F” is from about 1.5 inches to about 2 inches.

The invention also provides for a method of any one of: preventing a user's heels from contacting a surface; maintaining a user's heel elevated if the user shifts position; preventing a user's heels from contacting a surface when the user is positioned either horizontally on their back or laterally on their side; preventing a user's heels from contacting a surface should the user change position; preventing hyperextension of the knees and/or hips of a used; minimizing or preventing hip or knee contracture; preventing hyperextension of the knees of a user; and/or offering sufficient support to maintain the legs in a flat position.

### BRIEF DESCRIPTION OF THE DRAWINGS

The foregoing features of embodiments will be more readily understood by reference to the following detailed description, taken with reference to the accompanying drawings, in which:

FIG. 1 presents embodiments of the pillow.

FIG. 2 presents a top view of the pillow.

FIG. 3 presents a side view of an embodiment of the pillow.

FIG. 4 presents a distal end view of an embodiment of the pillow.

FIG. 5 presents a proximal end view of an embodiment of the pillow.

FIG. 6 depicts a user lying horizontally on his back on one embodiment of the pillow.

FIG. 7 depicts a user lying horizontally on his back on one embodiment of the pillow.

FIG. 8 depicts a user lying horizontally on his back on one embodiment of the pillow.

FIG. 9 depicts a user lying on his side on one embodiment of the pillow.

FIG. 10A-D presents alternative embodiments of the pillow.

### DETAILED DESCRIPTION OF THE INVENTION

The invention relates generally to a pillow for supporting the lower leg of a subject and a method of using the pillow. The invention relates to a pillow with a for prevention and treatment of skin ulcers, for example, ulcers located on the heel(s) of a subject and methods of use. The invention provides for a pillow with a substantially T-shape. The pillow and the methods of use described herein provide numerous unexpected advantages as compared to pillows currently known in the art.

The pillow, for example a T-shaped pillow, prevents the user's heels from contacting a surface, thereby treating or preventing skin ulcers of the heels. The T-shape of the pillow of the invention offers the advantage of keeping the user's heel elevated even if the user shifts position, for example, from a horizontal position to a lateral position. In particular, the T-shape design of the pillow offers the advantage of preventing the user's heels from contacting a surface when the user is positioned either horizontally on their back or laterally on their side. The pillow therefore prevents the user's heels from contacting a surface should the user change position, for example, while sleeping. This is an advantage over rectangular pillows known in the art wherein if a user shifts from a horizontal orientation on their back to a lateral position, their legs will fall off the side of the pillow, thereby allowing formation of skin ulcers on the sides of the heels. This can occur if a rectangular pillow is oriented under the user's legs in a vertical position.

The pillow comprises a dense material that maintains the leg(s) in a flat position and prevents hyperextension of the knees and/or hips. This is clearly an advantage over pillows known in the art as such pillows maintain the legs in a bent position such that the knees are at an angle, for example, a 30° or 45° angle, thereby causing hip or knee contracture and subsequent discomfort to the user. The pillow also prevents hyperextension of the knees of a user.

The dense pillow described herein is also an improvement over pillows known in the art that do not comprise a dense material, for example a traditional pillow which is typically used to support the head and is currently used to elevate the heels of a subject, as such pillows do not offer sufficient support to maintain the legs in a flat position.

The pillow of the invention is easy to position correctly thereby decreasing patient discomfort and movement associated with positioning and adjusting a pillow known in the art. The shape of the pillow of the invention, for example the T-shape, facilitates positioning and proper alignment of the user. In addition, the pillow of the invention is available in a number of different sizes thereby ensuring that the pillow is positioned correctly and correctly fits the user for maximum effect without discomfort.

Unlike pillows known in the art, the beveled shape at the top and bottom of the pillow prevents excess pressure from being placed on the hips or knees of the user. In addition, the pillow is designed such that there are no seams present at any position that would be in contact with the skin of the user and cause skin irritation.

In addition to preventing or treating the formation of skin ulcers, the pillow improves the circulation of the user. In addition, elevation of the lower extremities by the pillow reduces edema of the lower extremities.

The pillow is useful for treating or preventing heel ulcers in at least surgical patients, for example patients that have undergone knee surgery or knee or hip replacement, elderly subjects at high risk of forming decubitus ulcers, quadriplegics, paraplegics, as well as individuals diagnosed with diabetes, anemia, and/or peripheral vascular disease.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### DETAILED DESCRIPTION OF PREFERRED EMBODIMENTS

Referring now to the drawings, FIG. 1 discloses the preferred embodiment of the pillow. The pillow comprises a proximal end, a distal end, a bottom surface, a top surface, a front surface, a rear surface a left side surface and a right side surface. The pillow also comprises an interior.

The pillow is preferably sized so that it allows the user to be positioned such that when the user is on their back the user's legs are supported from about the bottom edge of the knees to the ankles. The pillow is also preferably sized so that when the user is positioned on their side, the user's legs are supported from just below the bottom edge of the knees to the ankles.

The edge of the pillow comprising the distal end and the front surface is beveled. The edge of the pillow comprising the proximal end and the back surface is also beveled.

The preferred embodiment for the interior of the pillow is heavy density, firm and extra firm upholstery foam rubber, for example, memory foam. The foam of choice is designated as dense upholstery foam and is available online from Fabric Store Inc. In one embodiment, the interior of the pillow comprises a gel inset. In another embodiment, the interior of the pillow is memory foam and/or gel insets. In one embodiment the interior of the pillow is not a plurality of beads, wherein a bead includes but is not limited to seeds, such as flax, mustard or sesame seeds, buckwheat, millet, popcorn kernels, synthetic foam beads, shredded rubber, or other bead material that can comprise the interior of a pillow.

In one embodiment the pillow is sized such that the user's legs are substantially flat, the heels are elevated, and there is no hyperextension of the knees or hips. The pillow can be provided in different sizes. For example, for a T-shaped pillow, from 4″ to 20″ from the distal end to the “T” or cross of the “T”, for example, 4″, 5″, 6″, 7″, 8″, 9″, 10″, 11″, 12″, 13″, 14″, 15″, 16″, 17″, 18″, 19″ or 20″. The invention provides for a pillow of at least the following different sizes, pediatric, from about 6 inches to about 8 inches from the distal end to the “T” or cross of the “T”; “small: from about 10 inches to about 12 inches from the distal end to the “T” or cross of the “T”; medium, from about 12 inches to about 14 inches from the distal end to the “T” or cross of the “T”; tall, from about 14 inches to about 18 inches from the distal end to the “T” or cross of the “T”; and bariatric (pediatric, small, medium or large in length but with a depth of 4 inches or more).

With respect to FIG. 1, the pillow of the invention can have any combination of the following dimensions for the lengths indicated in FIG. 1, as “A”, “B”, “C”, “D”, “E”, “F” and “G”. The invention provides for a pillow wherein distance “A” is from about 4 inches to about 20 inches, for example, 4″, 5″, 6″, 7″, 8″, 9″, 10″, 11″, 12″, 13″, 14″, 15″, 16″, 17″, 18″, 19″ or 20″. The invention also provides for a pillow wherein distance “B” is from about 1 inch to about 8 inches, for example, 1″, 2″, 3″, 4″, 5″, 6″, 7″ or 8″. The invention also provides for a pillow wherein distance “C” is from about 5 inches to about 28 inches, for example, 5″, 6″, 7″, 8″, 9″, 10″, 11″, 12″, 13″, 14″, 15″, 16″, 17″, 18″, 19″, 20″, 21″, 22″, 23″, 24″, 25″, 26″, 27″ and 28″. The invention also provides for a pillow where distance “D” is from about 18 inches to about 32 inches, for example, 18″, 19″, 20″, 21″, 22″, 23″, 24″, 25″, 26″, 27″, 28″, 29″, 30″, 31″, and 32″. The invention also provides for a pillow wherein distance “E” is from about 10 inches to about 24 inches, for example, 10″, 11″, 12″, 13″, 14″, 15″, 16″, 17″, 18″, 19″, 20″, 21″, 22″, 23″ and 24″. The invention also provides for a pillow wherein distance “F” is from about 0.5 inches to about 8 inches, for example, 0.5″, 1″, 1.5″, 2″, 3″, 4″, 5″, 6″, 7″ or 8″. The invention also provides for a pillow wherein distance “G” is from about 2 inches to about 8 inches, for example, 2″, 3″, 4″, 5″, 6″, 7″ or 8″.

The invention provides for a pillow wherein distance “A” is from about 10 inches to about 12 inches, and distance “F” is from about 3 inches to about 4 inches. The also invention provides for a pillow wherein distance “A” is from about 12 inches to about 14 inches, and distance “F” is from about 3 inches to about 4 inches. The invention also provides for a pillow wherein distance “A” is from about 14 inches to about 18 inches, and distance “F” is from about 3 inches to about 4 inches. The invention also provides for a pillow wherein distance “A” is from about 6 inches to about 8 inches, and distance “F” is from about 1.5 inches to about 2 inches. The invention also provides for a pillow wherein distance “A” is from about 8 inches to about 10 inches, and distance “F” is from about 1.5 inches to about 2 inches. The invention provides for a pillow wherein distance “A” is from about 10 inches to about 12 inches, and distance “F” is from about 1.5 inches to about 2 inches.

The invention also provides for a pillow that is not a T-shape pillow but has a length from the distal end to the proximal end of about 10 inches to about 24 inches, and a width from around 12 inches to around 30 inches.

Certain users prefer to rest on their backs, and depending upon their medical condition, this position may be preferred to a sideways position. FIGS. 6-8 depict a patient resting in a generally prone position on his/her back with his/her legs supported from about the bottom edge of the knees to the ankles. The heels are elevated and do not touch any surface, for example, the surface of a bed.

Certain users prefer to rest on their side, and depending on their medical condition, this position may be preferred to a position on their back. FIG. 9 depicts a patient resting generally on their side with his/her legs supported from just below the bottom edge of the knees to the ankles.

In certain embodiments the pillow further comprises a cover. Preferably the cover is waterproof and washable such that the pillow can be reused. In other embodiments the pillow comprises a cover and also comprises a netting that provides for wicking of moisture away from the skin and prevents the user's legs from sticking or adhering to the surface of the pillow. In certain embodiments, the cover is non-porous.

FIG. 10A-D discloses additional embodiments of the invention, for example wherein the protruding portions are substantially square, wherein the protruding portions are not perpendicular to the left and right side of the pillow, wherein the protruding portions are neither substantially rectangular or square in shape and wherein the edges or the protruding portions are rounded.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A pillow for preventing the heels of a user from contacting a surface, the pillow having a proximal end and a distal end, the pillow having a length extending between the proximal end and the distal end; and
the length of the pillow being about equal to or less than the length from the user's knees to the user's ankles.

2. The pillow of claim 1, wherein the distal end has two opposing protruding portions substantially forming a T-shape.

3. The pillow of claim 1, comprising a top surface and a bottom surface, the top and bottom surface being substantially flat.

4. The pillow of claim 1, wherein the pillow comprises a left side surface and a right side surface.

5. The pillow of claim 1, wherein the pillow comprises a front surface and a rear surface.

6. The pillow of claim 1, wherein the edge comprising the distal end and the front surface is beveled.

7. The pillow of claim 1, wherein the edge comprising the proximal surface and the back end is beveled.

8. The pillow of claim 1, wherein the interior comprises a dense material.

9. The pillow of claim 1, wherein the dense material is selected from the group consisting of: foam, memory foam and gel.

10. The pillow of claim 1, further comprising a cover.

11. The pillow of claim 1, wherein the cover of the pillow is waterproof.

12. The pillow of claim 1, wherein the cover of the pillow can be cleaned.

13. The pillow of claim 1, further comprising a material to provide for wicking moisture away from the user.

14. The pillow of claim 1, wherein the protruding portions are substantially rectangular.

15. The pillow of claim 1, wherein the protruding portions are substantially square.

16. The pillow of claim 1, wherein the protruding portions are not perpendicular to the left and right side of the pillow.

17. The pillow of claim 1, wherein the distal end has two protruding portions substantially comprising a Y-shape.

18. The pillow of claim 1, wherein the protruding portions are neither substantially rectangular or square and wherein the edges or the protruding portions are rounded

19. A method of preventing formation of pressure sores on the heels of a subject comprising:
providing a pillow having a proximal end and a distal end, the pillow having a length extending between the proximal end and the distal end; and
positioning the subject's legs over the pillow, the subject's feet extending past the distal end, the subject's ankles being about aligned with the distal end,
the length being about equal to or less than the length from the subject's knee to the subject's ankles.

20. The method of claim 19, wherein the subject is positioned horizontally on their back.

21. The method of claim 19, wherein the subject is positioned on their side.

22. The method of claim 21, wherein the subject's feet extend beyond the distal end of the pillow.

23. The method of claim 19, wherein the portion of the user's legs that contact the pillow are substantially flat.

24. The method of claim 19, wherein the portion of the user's legs that contact the pillow are substantially straight.

25. The pillow of claim 1, wherein with reference to FIG. 1, the pillow of the invention has dimensions wherein:
distance “A” is from about 4 inches to about 20 inches;
distance “B” is from about 1 inch to about 8 inches;
distance “C” is from about 5 inches to about 28 inches;
distance “D” is from about 18 inches to about 32 inches;
distance “E” is from about 10 inches to about 24 inches;
distance “F” is from about 0.5 inches to about 8 inches; and
distance “G” is from about 2 inches to about 8 inches.

26. The pillow of claim 1, wherein with reference to FIG. 1, the pillow of the invention has dimensions wherein: distance “A” is from about 10 inches to about 12 inches, and distance “F” is from about 3 inches to about 4 inches.

27. The pillow of claim 1, wherein with reference to FIG. 1, the pillow of the invention has dimensions wherein: distance “A” is from about 12 inches to about 14 inches, and distance “F” is from about 3 inches to about 4 inches.

28. The pillow of claim 1, wherein with reference to FIG. 1, the pillow of the invention has dimensions wherein distance “A” is from about 14 inches to about 18 inches, and distance “F” is from about 3 inches to about 4 inches.

29. The pillow of claim 1, wherein with reference to FIG. 1, the pillow of the invention has dimensions wherein distance “A” is from about 6 inches to about 8 inches, and distance “F” is from about 1.5 inches to about 2 inches.

30. The pillow of claim 1, wherein distance “A” is from about 8 inches to about 10 inches, and distance “F” is from about 1.5 inches to about 2 inches.

31. The pillow of claim 1, wherein distance “A” is from about 10 inches to about 12 inches, and distance “F” is from about 1.5 inches to about 2 inches.
